(19) United States
(12) Patent Application Publication
(10) Pub. No.: US 2011/0068899 A1
(43) Pub. Date: Mar. 24, 2011

(54) Method and System for Controlling Electronic Devices

(76) Inventors: Maksim Ioffe, San Francisco, CA (US); David Chia-Wen Lean, San Francisco, CA (US); Crx Kyumin Chai, Oakland, CA (US)

(21) Appl. No.: 12/889,190

(22) Filed: Sep. 23, 2010

Related U.S. Application Data
(60) Provisional application No. 61/245,179, filed on Sep. 23, 2009.

(51) Int. Cl. G08B 5/22; G08B 25/00

(52) U.S. Cl. 340/8.1

(57) ABSTRACT

A method and system for controlling electronic devices are disclosed. According to one embodiment, a computer-implemented method comprises accessing a physical location having location coordinates, defining a location name for the physical location, identifying a controllable device within the physical location, defining privacy settings for the physical location, wherein the privacy settings control access to the controllable device, and transmitting the location name, location coordinates, controllable device information, and privacy settings to a server.

The present application claims the benefit of application Ser. No. 61/245,179, titled “A METHOD AND SYSTEM FOR CONTROLLING ELECTRONIC DEVICES,” filed on Sep. 23, 2009, and is hereby incorporated by reference in its entirety.

### FIELD

The field of the invention relates generally to computer systems. In particular, the present invention is directed to a method and system for controlling electronic devices.

### BACKGROUND

A universal remote is a remote control that can be programmed to operate various brands of one or more types of consumer electronics devices. Low-end universal remotes can only control a set number of devices determined by their manufacturer, while mid- and high-end universal remotes allow the user to program in new control codes to the remote. Many remotes sold with various electronic devices include universal remote capabilities for other types of devices, which allow the remote to control other devices beyond the device it came with. For example, a VCR remote may be programmed to operate various brands of televisions. Because programming a universal remote can be a fairly complex procedure, it is most often performed by technically-minded individuals, although non-technical users can often operate the remote after it has been programmed.

### SUMMARY

A method and system for controlling electronic devices are disclosed. According to one embodiment, a computer-implemented method comprises accessing a physical location having location coordinates, defining a location name for the physical location, identifying a controllable device within the physical location, defining privacy settings for the physical location, wherein the privacy settings control access to the controllable device, and transmitting the location name, location coordinates, controllable device information, and privacy settings to a server.

The above and other preferred features, including various novel details of implementation and combination of elements, will now be more particularly described with reference to the accompanying drawings and pointed out in the claims. It will be understood that the particular methods and implementations described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

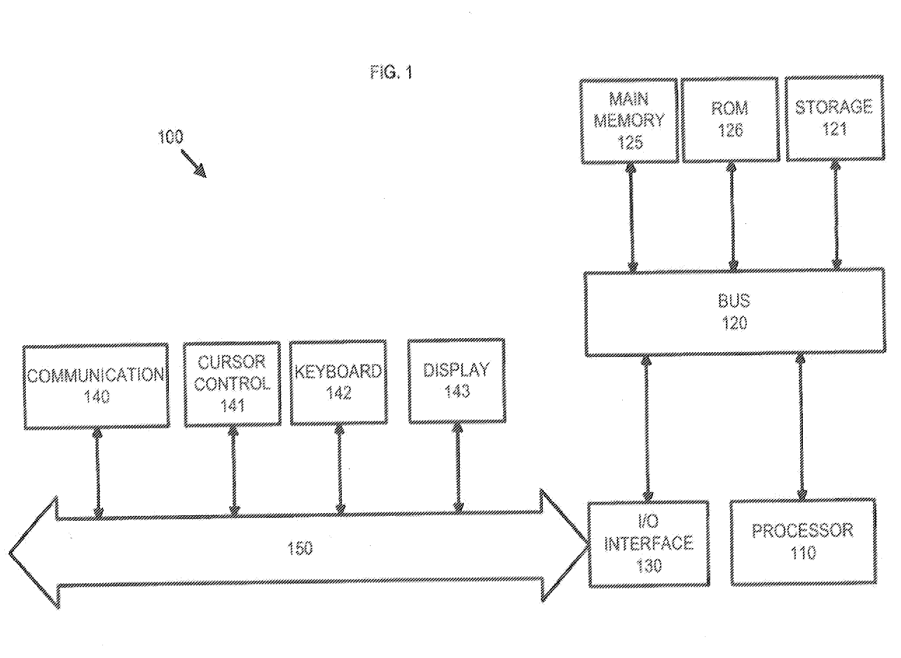

FIG. 1 illustrates an exemplary computer architecture for use with the present system, according to one embodiment.

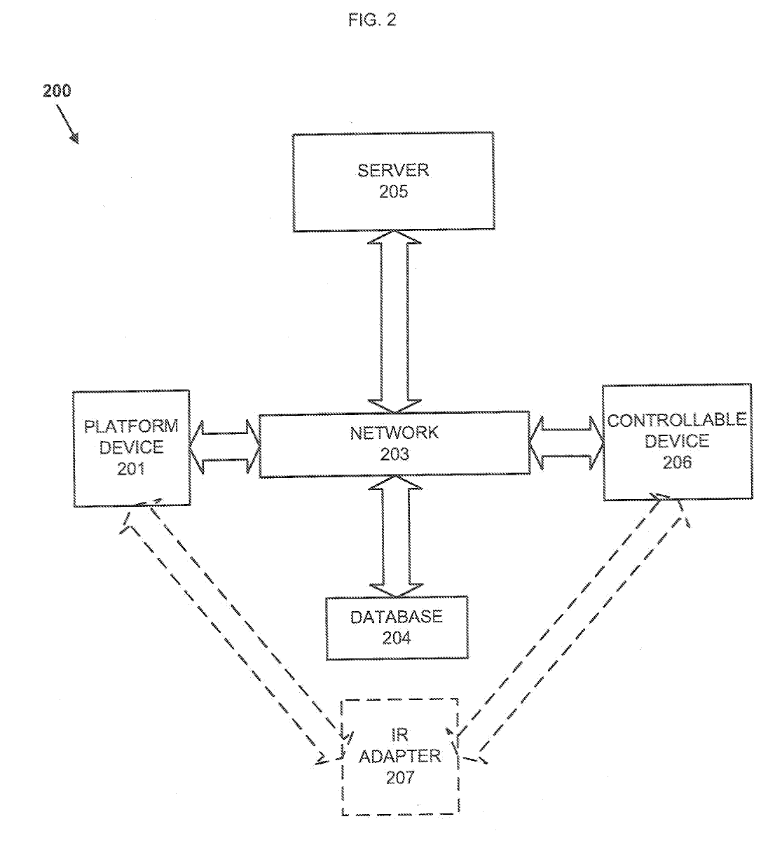

FIG. 2 illustrates an exemplary system architecture for use with the present system, according to one embodiment.

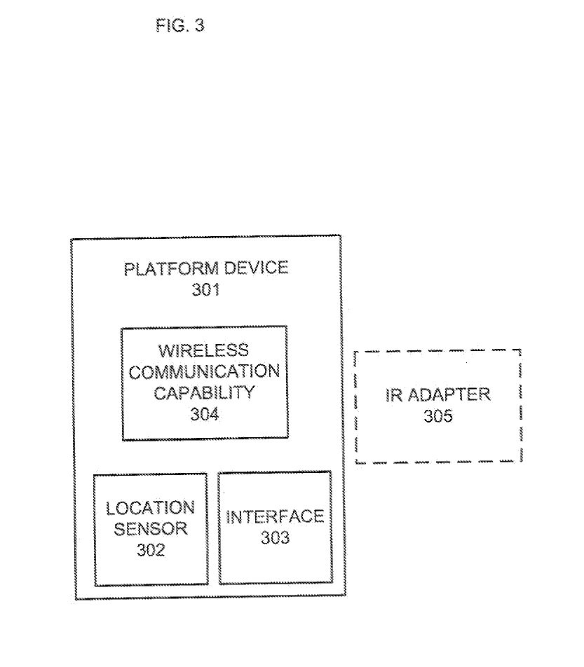

FIG. 3 illustrates an exemplary platform device for use with the present system, according to one embodiment.

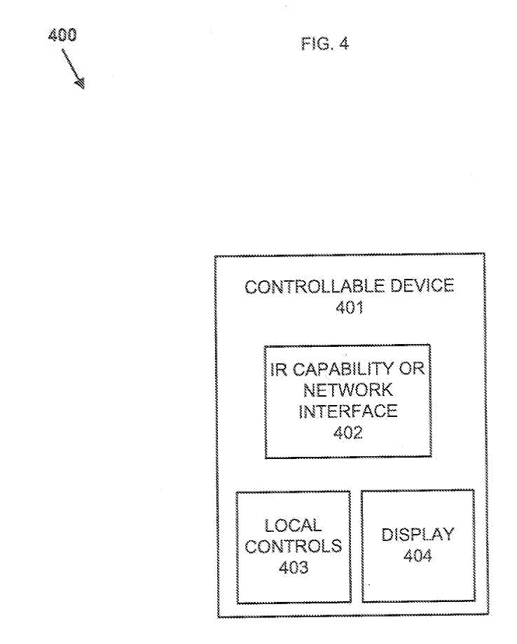

FIG. 4 illustrates an exemplary controllable device for use with the present system, according to one embodiment.

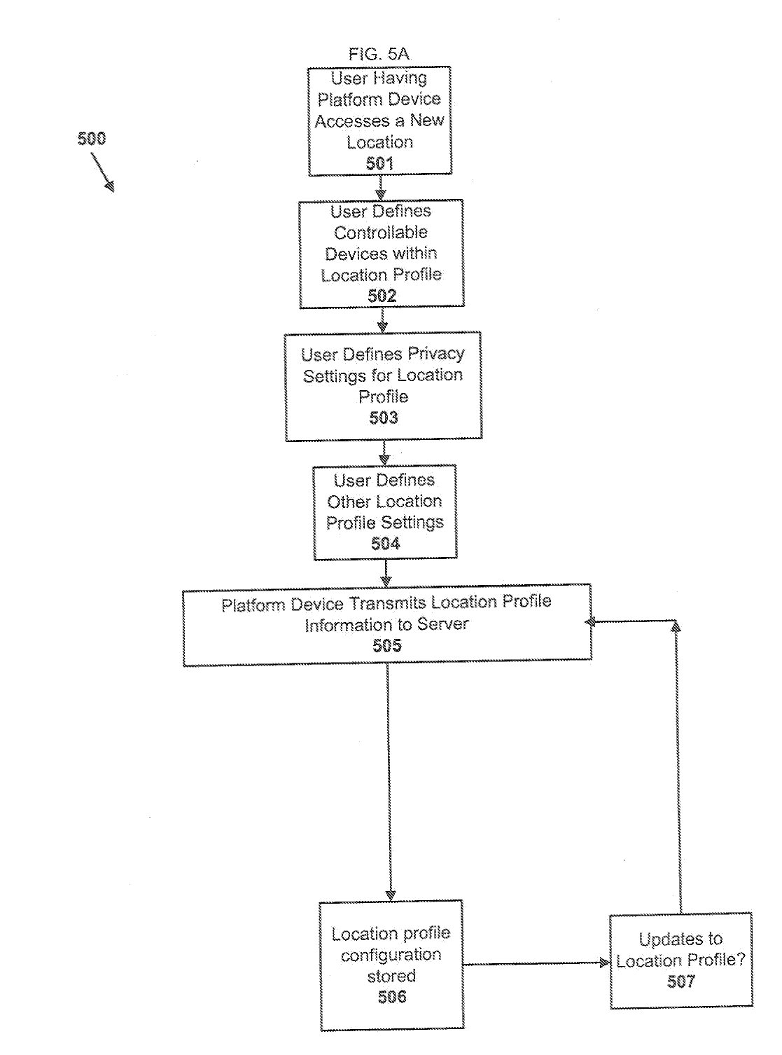

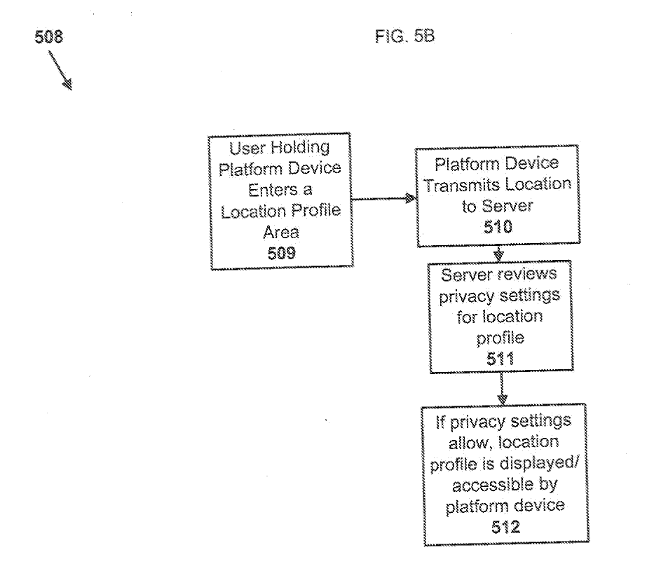

FIG. 5A illustrates an exemplary location profile configuration process for use with the present system, according to one embodiment.

FIG. 5B illustrates an exemplary location recognition process for use with the present system, according to one embodiment.

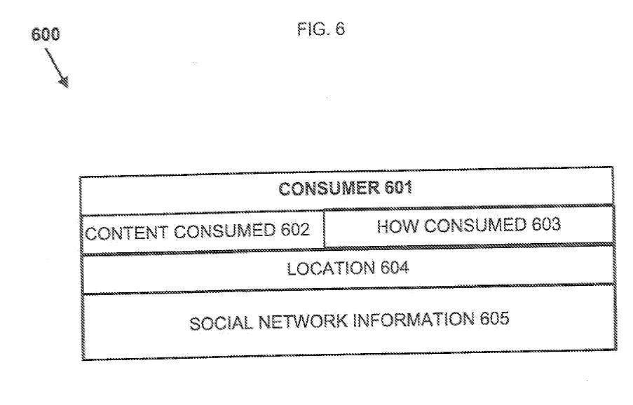

FIG. 6 illustrates an exemplary consumer database entry for use with the present system, according to one embodiment.

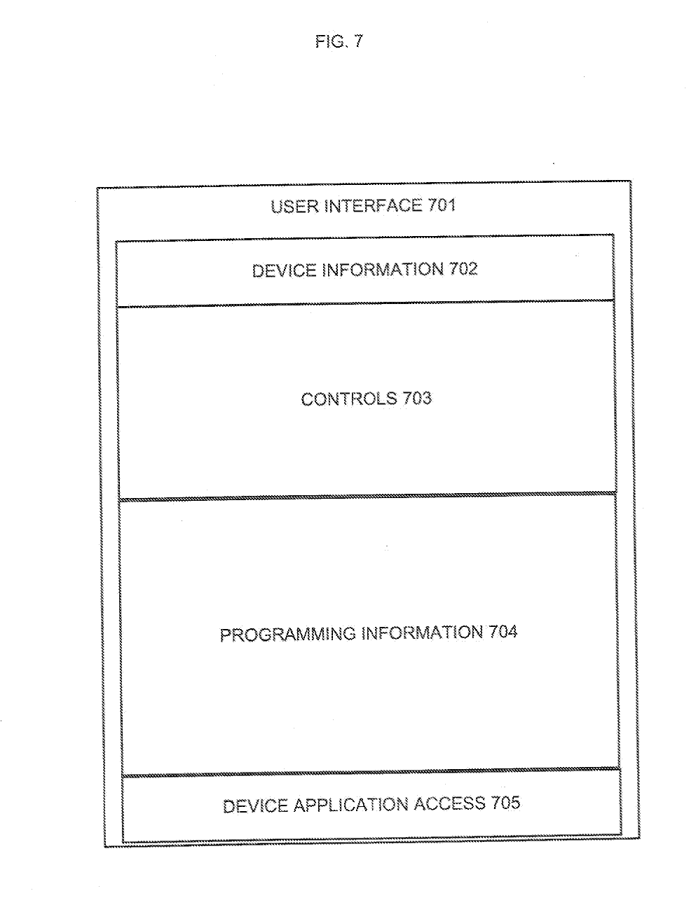

FIG. 7 illustrates an exemplary user interface for use with the present system, according to one embodiment.

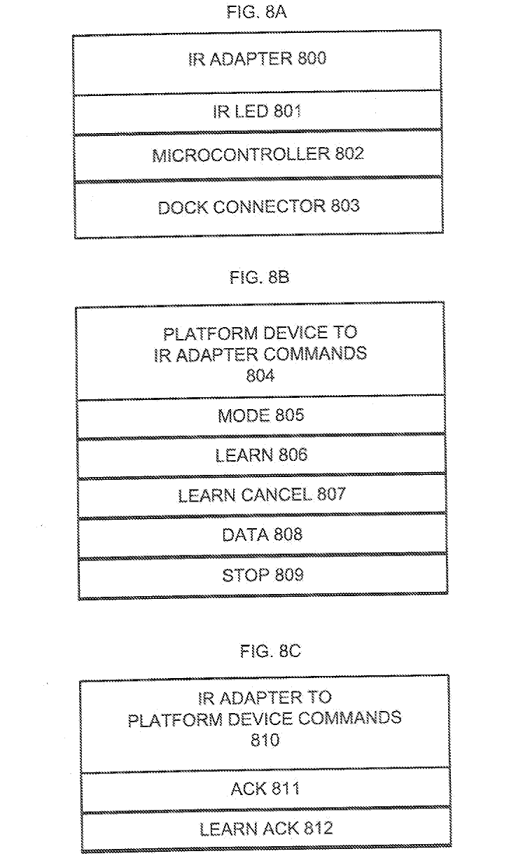

FIG. 8A illustrates an exemplary infrared adapter for use with the present system, according to one embodiment.

FIG. 8B illustrates exemplary commands to transmit from a platform device to a controllable device within the present system, according to one embodiment.

FIG. 8C illustrates exemplary commands to transmit from a controllable device to a platform device within the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method and system for controlling electronic devices are disclosed. According to one embodiment, a computer-implemented method comprises accessing a physical location having location coordinates, defining a location name for the physical location, identifying a controllable device within the physical location, defining privacy settings for the physical location, wherein the privacy settings control access to the controllable device, and transmitting the location name, location coordinates, controllable device information, and privacy settings to a server.

According to one embodiment, the present system comprises a frontend and a backend. The frontend executes on a device such as a mobile device (herein referred to as a platform device). The platform device communicates with the backend that resides on a server. The communication between the frontend and the backend takes place over any IP-capable and Internet-connected communications medium, such as a WiFi or a cellular network, or a combination of both.

According to one embodiment, the present system utilizes location sensors on the platform device to determine the set of controllable devices that can be controlled by the platform device as well as the device-specific methods used to control them. The information describing the controllable devices, their locations, and their control methods is stored on a backend server and is retrieved by the platform device over the network. Retrieval and consequent updates to a graphical user interface (GUI) on the platform device happen automatically, triggered by the detection of a change in the location of the platform device.

According to one embodiment, the logical association of a location to a location, name, a set of devices and their control methods, and optionally a set of privacy settings is configured as a location profile.

According to one embodiment, an exemplary implementation includes a hotel operator enabling guests to control what is displayed on a communal big-screen TV in the hotel lounge. The hotel operator creates the lounge location profile. Any hotel guest with an enabled platform device is automatically presented with an intuitive way to control the lounge entertainment system.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage, medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or, other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 125 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates an exemplary system architecture for use with the present system, according to one embodiment. An exemplary system architecture 200 includes a server 205 in communication with a network 203. A platform device 201 running a software application according to the present system is also in communication with the network 203. A controllable device 206 is in communication with the platform device 201 either directly through the network 203 or through an IR adapter 207 that enables the platform device to send it, direct signals (an exemplary IR adapter is depicted in FIG. 8A). A database 204 for storing device information is also in communication with the network 203. The server 205, platform device 201, and database 204 can have similar architectures as that described in FIG. 1, according to one embodiment.

FIG. 3 illustrates an exemplary platform device for use with the present system, according to one embodiment. An exemplary platform device 301 includes at least one location sensor 302, an interface 303, and wireless communication capability 304. The location sensor 302 senses the platform device location. The interface 303 provides an input and output means for a user. Wireless communication capability 304 allows for communication with other devices over a network. As described below in FIG. 8A, a platform device may be modified to include an IR adapter 305 to allow for IR capability. The IR adapter 305 can either be attached directly to the'platform device, or be a detached adapter placed in the vicinity of the platform device.

According to one embodiment, examples of mobile or platform devices include smartphones (e.g. Apple iPhone), tablet devices, and media players. According to one embodiment, the location sensors include GPS and mobile tracking techniques (cell identification and triangulation).

FIG. 4 illustrates an exemplary controllable device for use with the present system, according to one embodiment. An exemplary controllable device 401 includes local controls 403, a display 404, and infrared (IR) or network interface 402. The local controls 403 control the device functionality, such as volume and playback. The display 404 communicates messages regarding device functionality, according to one embodiment.

According to one embodiment, examples of controllable devices include digital video recorders (DVRs), TiVO, televisions, media receivers, blu-ray players, DVD players, media players, projectors, VCRs, home automation devices, and set top boxes.

FIG. 5A illustrates an exemplary location profile configuration process for use with the present system, according to one embodiment. An exemplary location profile configuration process 500 begins when a platform device, held by a user, accesses a new location 501.

The user defines the location profile by entering information into the software application hosted on the platform device. The user defines controllable devices within the location profile 502. The controllable devices can be selected from a list of typical defined controllable devices (e.g. DVR, TiVO), and the user can define a new controllable device through the software interface. The user defines privacy settings for the location profile 503 and defines any other settings for the location profile 504. The platform device transmits the location profile information to the server 505. Location profile information (referred to herein also as location profile configuration) includes a location name, location coordinates, controllable device information, and privacy settings. The location profile configuration is stored 506 at the server or database. If any of the location profile information is updated through the application on the platform device, the location profile configuration is updated on the server or database (herein referred to as backend) as well. The storing of profile information is either done locally on the server or to a database in communication with the server and network, according to an architecture described in FIG. 2.

The user may not be comfortable opening up the control of her home electronics to the entire world. Likewise, a casual passer-by may not care to be presented with dozens of irrelevant location profiles as she is walking past a residential high-rise. To solve this problem, the location profiles can be made available to specific sets of users. One such set is the set of the user's social connections, as maintained by a social networking service such as Facebook. Integration with social networking services is done through open APIs (e.g., Facebook Connect).

According to one embodiment, three privacy settings are available. A private setting makes the location profile available only to the user. A public setting makes the location profile available to everyone. A socially public setting makes the location profile available to a subset of the user's social graph.

FIG. 5B illustrates an exemplary location recognition process for use with the present system, according to one embodiment. An exemplary location recognition process 508 begins with a user holding a platform device entering a location profile area 509. The platform device transmits its location to the server 510, and the server recognizes that the platform device is within a defined location profile area. The server reviews privacy settings for the location profile 512, and if the privacy settings allow, the location profile is displayed to the user and accessible through the user's platform device 513.

FIG. 6 illustrates an exemplary consumer database entry for use with the present system, according to one embodiment. According to one embodiment, the frontend of the present system reports user interactions and content consumption to the backend. Whenever relevant, an electronic programming guide (EPG; colloquially known as “TV Guide”) is presented to the user on the platform device. The EPG is compiled to reflect the exact channel line-up provided by the service provider. An EPG is not restricted to just cable or satellite service providers. An EPG feature is applicable to other services, examples include but are not limited to Netflix, Hulu, and any video on demand providers. The EPG interface is presented as an interactive table, and allows the user to tune to a given channel or watch a given piece of content. Each tune in event is transmitted to and recorded by the backend.

It is common to have a Digital Video Recorder (DVR) device as part of the overall entertainment system. In this case, DVR controls are presented on the appropriate user interface screen. Once again, the backend keeps track of every single invocation of the DVR controls. Other service providers, examples included above in, reference to EPG features, also allow similar levels of playback control to display and track in the present system.

An exemplary consumer database entry 600 for use with the present system includes an entry identifying the consumer 601, the content consumed 602 by the consumer 601, and how the content was consumed 603. An entry for the location 604 of consumption is stored, as well as any social network information 605 associated with the consumer 601.

Keeping track of this information allows the present system to construct a database of what content a given user has consumed and how in particular it was consumed. This model lends itself to very useful types of analytics, which are described below.

According to one embodiment, a real-time sorted list is constructed of consumed content within a constrained geographic area (neighborhood, ZIP code, city, state, country). The list is sorted in descending order by the number of viewers, allowing a user to identify what is hot right now in her geographic area.

According to one embodiment, a list is constructed of content that has been trending up in a user's geographic area in the last X number of days or weeks, giving the user another way to discover new content.

According to one embodiment, a user's social network is discovered using social network services' APIs (e.g. Facebook Connect), and the user's usage data is linked to these social connections. A real-time sorted list is constructed of what content is being consumed in the user's social network. The list is sorted in descending order by the number of viewers, allowing a user to identify what is hot right now in her social circle.

According to one embodiment, for a given user, this sorting is further enhanced by considering usage data from users having two or more degrees of social separation from the user. These second- and N-order inputs are given correspondingly less weight.

According to one embodiment, a list is constructed of content that has been trending up in a user's social circle in the last X number of days or weeks, giving the user another way to discover new content.

According to one embodiment, collaborative filtering is utilized to make content recommendations based on the user's past content consuming habits relative to content consumption by other users. For a given user, the present system constructs a sorted list of currently available content that the user is likely to be interested in.

According to one embodiment, the present system constructs a list of content that, based on a collaborative filtering analysis, has been trending up for the user for the past X number of days or weeks.

According to one embodiment, a combination of collaborative filtering and social network information is used to construct a list of content to recommend to a user.

According to one embodiment, third parties (e.g. content producers, industry analysts, and service providers) access the present system through an interface to run various analytics on the usage data As an example, these analytics include the following queries:
What is the relative popularity of a given broadcast channel?
What is the demographic data for a given piece of content?
What is the demographic data for a given broadcast channel?
For a given TV show, what does the number-of-viewers vs. time function look like? Did viewers get bored at some point in the show, making later advertisements less effective than earlier advertisements?
For a given demographic, what was the average effectiveness of a given advertisement?

According to one embodiment, effectiveness is defined as the average amount of time a given user was tuned into the advertisement when exposed to it as part of consuming some other underlying content.

FIG. 7 illustrates an exemplary user interface for use with the present system, according to one embodiment. An exemplary user interface 701 includes device information 702, controls for controlling a controllable device 703, programming information 704 such as available television programs according to a schedule, and various device application access 705. Device information 702 can include battery information, time, date, and wireless communication status. Device application access 705 can include yet is not limited to device settings, application settings, and other applications residing on the device.

According to one embodiment, the present system includes a customizable interface. The interface features context-specific controls, such as volume dials and EPG tables. The set of controls presented is customizable, allowing the user to configure the interface to suit her specific needs and environment. For example, the user may want to add a control for closed captioned choices if that is not part of the current or template interface.

According to one embodiment, for a given user's profile, the user interface is initially configured to conform to a certain template. The user can then can go and modify the set of controls to whatever suits her needs.

A control palette displayed to the user allows for easy selection of a specific function the user wants on the currently edited page. The control palette navigation is hierarchical: starting with a list of devices, the user drills down to the specific control she wants. After finding the control in the control palette, she drags it onto the main screen, thereby permanently placing the control on the current page. Once the controls are selected via the control palette, the user can then rearrange the placement of controls on the current page by dragging them into a desired configuration. The selected controls can also be deleted.

FIG. 8A illustrates an exemplary infrared adapter for use with the present system, according to one embodiment. An overwhelming majority of today's consumer electronics (CE) entertainment devices (controllable devices, herein) are controlled via proprietary infrared (IR) signals. These devices are not WiFi/IP enabled, and an out-of-the-box platform device cannot control them.

To overcome this limitation and to provide the most value to the user, an adapter is provided that converts data received via the platform device's dock connector into IR pulses recognized by a given controllable device.

An exemplary infrared (IR) adapter 800 includes an IR light emitting diode (LED) 801, a microcontroller 802, and a dock connector 803. As mentioned previously, the IR adapter can either be attached to the platform device, or be a standalone detached adapter for placement in the vicinity of the platform device and controllable device.

According to one embodiment, the IR adapter 800 is capable of emitting every single type of IR signal or series of IR signals used by CE manufacturers to encode control functions. The present frontend application running on a platform device sends digital data describing the IR signal via the dock connector 803. On the adapter side, the microcontroller 802, the brains of the circuit, communicates with the platform device, parses the received data and drives the IR LED 801.

FIG. 8B illustrates exemplary commands to transmit from a platform device to an IR adapter within the present system, according to one embodiment. Exemplary commands to transmit from a platform device to an IR adapter 804 include a MODE command 805, a LEARN command 806, a LEARN CANCEL command 807, a DATA command 808, and a STOP command 809. The MODE command 805 sets transmission parameters that are used by subsequent DATA commands. An exemplary packet format used by the MODE command 805 includes:

typedef struct {
uint8_t cmd;// 0x1
uint8_t frequency;// in kHz
uint8_t duty_cycle;
} app_to_acc_cmd_mode_t.

The LEARN command 806 tells the IR adapter to capture an IR signal from an existing platform device. An exemplary packet format used by the LEARN command 806 includes:

typedef struct {
uint8_t cmd;// 0x3
uint8_t reserved0;
uint8_t reserved1;
uint8_t reserved2;
} app_to_acc_cmd_learn_t.

The LEARN CANCEL command 807 tells the IR adapter to cancel a LEARN command. An exemplary packet format used by the LEARN CANCEL command 807 includes:

typedef struct {
uint8_t cmd;// 0x4
uint8_t reserved;
} app_to_acc_cmd_learn_cancel_t.

The DATA command 808 transmits data. An exemplary packet format used by the DATA command 808 includes:

typedef struct {
uint8_t cmd;// 0x7
uint8_t blast_repeat_count; // Number of blasts to send out
uint16_t once_sequence_count;
uint16_t repeat_sequence_count;
uint16_t once_on_time1;
uint16_t once_off_time1;
uint16_t once_on_time2;
uint16_t once_off_time2;
...
uint16_t once_on_timeN;
uint16_t once_off_timeN; // end of once sequence
uint16_t repeat_on_time1;
uint16_t repeat_off_time1;
uint16_t repeat_on_time2;
uint16_t repeat_off_time2;
...
uint16_t repeat_on_timeM;
uint16_t repeat_off_timeM; // end of repeat sequence
} acc_to_app_cmd_data2_t.

The STOP command 809 instructs the firmware to stop repeating a sequence given in a prior DATA command. An exemplary packet format used by the STOP command 809 includes:

typedef struct {
uint8_t cmd;// 0x8
} app_to_acc_cmd_stop_t.

FIG. 8C illustrates exemplary commands to transmit from an IR adapter to a platform device within the present system, according to one embodiment. Exemplary commands to transmit from an IR adapter to a platform device 810 include an ACK(acknowledgement) command 811, and a LEARN ACK command 812.

The ACK command 811 acknowledges receipt of a command from the platform device. An exemplary packet format used by the ACK command 811 includes:

typedef struct {
uint8_t cmd;// 0x1
uint8_t acked_cmd;// the command type being ack'd
} acc_to_app_cmd_ack_t.

An exemplary packet format used by the LEARN ACK command 812 includes:

typedef struct {
uint8_t cmd;// 0x1
uint8_t acked_cmd;// 0x3
uint8_t reserved0;
uint8_t status;
uint16_t number_of_elements; // # of uint16_ts that follow
uint16_t number_of_carrier_pulses;
uint16_t on_time1;// in microseconds
uint16_t off_time1;
uint16_t on_time2;
uint16_t off_time2;
...
uint16_t on_timeN;
uint16_t off_timeN;
} acc_to_app_cmd_ack_learn_t.

A method and system for controlling electronic devices have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer implemented method, comprising:
accessing a physical location having location coordinates;
defining a location name for the physical location;
identifying a controllable device within the physical location;
defining privacy settings for the physical location, wherein the privacy settings control access to the controllable device; and
transmitting the location name, location coordinates, controllable device information, and privacy settings to a server.

2. The computer implemented method of claim 1, wherein privacy settings are defined as one of public, private, or socially public.

3. The computer implemented method of claim 1, further comprising controlling the controllable device.

4. The computer implemented method of claim 3, wherein controlling the controllable device includes content consumption.

5. The computer implemented method of claim 4, wherein content consumption information is transmitted to and stored on the server.

6. The computer implemented method of claim 5, wherein analytics are calculated based on the content consumption information.

7. The computer implemented method of claim 6, wherein analytics are used to determine content to serve.

8. The computer implemented method of claim 1, wherein the controllable device is one of a digital video recorder (DVR), a TiVO, a television, a media receiver, a blu-ray player, a DVD player, a media player, a projector, a VCR, a home automation device, or a set top box.

9. The computer implemented method of claim 1, wherein the controllable device comprises one of infrared capability or a network interface.

10. A system, comprising:
a server in communication with a network; and
a platform device in communication with the network, wherein the platform device accesses a physical location having location coordinates;
defines a location name for the physical location;
identifies a controllable device within the physical location;
defines privacy settings for the physical location, wherein the privacy settings control access to the controllable device; and
transmits the location name, location coordinates, controllable device information, and privacy settings to the server.

11. The system of claim 10, wherein privacy settings are defined as one of public, private, or socially public.

12. The system of claim 10, wherein the platform device controls the controllable device.

13. The system of claim 12, wherein controlling the controllable device includes content consumption.

14. The system of claim 13, wherein content consumption information is transmitted to and stored on the server.

15. The system of claim 14, wherein analytics are calculated based on the content consumption information.

16. The system of claim 15, wherein analytics are used to determine content to serve.

17. The system of claim 10, wherein the controllable device is one of a digital video recorder (DVR), a TiVO, a television, a media receiver, a blu-ray player, a DVD player, a media player, a projector, a VCR, a home automation device, or a set top box.

18. The system of claim 10, wherein the controllable device comprises one of infrared capability or a network interface.

19. The system of claim 10, wherein the platform device is one of a smartphone, a tablet device, or a media player.

20. The system of claim 10, wherein the platform device comprises wireless communication capability, a location sensor, and a user interface.

21. The system of claim 21, wherein the user interface is customizable.

22. The system of claim 10, further comprising an infrared adapter, wherein the infrared adapter comprises an infrared LED, a microcontroller, and a dock connector.

23. The system of claim 22, wherein the infrared adapter is connected to the platform device.
